(19) United States
(12) Patent Application Publication
(10) Pub. No.: US 2024/0037391 A1
(43) Pub. Date: Feb. 1, 2024

(54) IMPROVED DISTRIBUTED TRAINING OF GRAPH-EMBEDDING NEURAL NETWORKS

(71) Applicant: Orange, Issy-les-Moulineaux (FR)

(72) Inventors: Lan Wang, Beijing (CN); Lei Yu, Beijing (CN); Li Jiang, Beijing (CN)

(21) Appl. No.: 18/258,523

(22) PCT Filed: Dec. 15, 2021
(86) PCT No.: PCT/IB2021/000906

§ 371 Date: Jun. 20, 2023

(30) Foreign Application Priority Data
Dec. 22, 2020 (WO) PCT/CN2020/138290

(51) Int. Cl. G06N 3/08

(52) U.S. Cl. CPC G06N 3/08

(57) ABSTRACT

A method for distributed training of a graph-embedding neural network is disclosed. The method, performed at a first server, includes computing, based on a first input data sample, first model data and first embedding data of a first graph neural network, the first graph neural network corresponding to a first set of nodes of a graph that are visible to the first server, and includes sharing the first model data and the first embedding data with a second server. The method also includes receiving second embedding data from a third server, the second embedding data comprising embedding data of a second graph neural network corresponding to a second set of nodes of the graph that are invisible to the first server, and includes computing second model data of the first graph neural network based on a second input data sample and the embedding data of the second graph neural network.

### FIELD OF THE INVENTION

The present invention relates generally to neural networks and more particularly to graph-embedding neural networks.

### TECHNICAL BACKGROUND

s Graphs as data representations are used in a wide variety of applications, constructs, and scenarios. For example, as shown in FIG. 1, graphs may be used to represent a communication network (e.g. an Internet of Things (IoT) network), a molecule, elements of an image, or a social network, to name a few examples.

Graph analysis provides insights regarding information embedded into the graph. Graph analytics is a field that concerns itself with the analysis of graphs to extract deep insights of what is behind the data. However, while graph analytics can be a powerful tool to understand the data represented by graphs, existing graph analytics methods suffer from high computational and space cost.

Graph embedding provides an alternative approach to the graph analytics problem. It converts the graph data into a low-dimensional space in which the graph information is preserved. By representing a graph as a set of one or more low-dimensional vectors, processing of the resulting data can be performed efficiently.

For the purpose of illustration, FIG. 2 illustrates the graph embedding of an example graph 202 which represents a Karate club. The nodes in the graph may represent the members of the club, and the edges of the graph may represent relationships between the members. Each node in the graph may be associated with respective features. The node features may represent characteristics of the member (e.g., age, gender, etc.) that the node represents. Two nodes in the graph may be connected when they have features in common, or in other words the respective members they represent share characteristics in common (e.g., age, gender, level, etc.).

The representation 204 represents the projection of the graph embedding of graph 202 onto a two-dimensional space. Specifically, in this example, the graph embedding produces a low-dimensional vector, hereinafter called “node embedding,” for each node in the graph. The projection of the node embeddings onto the two-dimensional space results in clusters as shown in FIG. 2. The clusters provide a clear and simple representation of the information embedded in the graph. Specifically, it can be clearly seen that nodes having common features (represented using the same geometrical form in FIG. 2) are grouped together into clusters in the two-dimensional representation 204.

Graph embedding comes in different flavors, depending on which element or elements of the graph are represented by the low-dimensional space representation. For example, depending on application needs, the low-dimensional space representation may represent the nodes in the graph (as shown in FIG. 2 for example), the edges of the graph, or even the whole graph, to name a few examples. For the purpose of simplification, the description hereinafter will be based on node-based graph embedding. A person of skill in the art will appreciate that other types of graph embeddings may be used for the purpose of this disclosure.

According to node-based graph embedding, a graph neural network (GNN) is constructed based on the graph. The GNN has an input layer, one or more successive hidden layers, and an output layer. The output layer provides the final embeddings (i.e., vector representations) for the nodes of the graph.

The input layer receives the input of the neural network and may adapt it for processing by the successive hidden layers. In node-based graph embedding, the input consists of a plurality of feature vectors, one for each node in the graph. The feature vector for a node contains information representing the features of the node. As described with respect to the example of FIG. 2 above, the node features may correspond to the characteristics of the element that the node represents.

The hidden layers connect the input layer to the output layer. Specifically, they enable for each node in the graph a computational path for obtaining the final node embedding based on the input. The computational graph is designed based on the connectivity information of the graph, namely how the nodes in the graph are connected to each other.

For the purpose of illustration, FIG. 3 illustrates an example computation path 302 that may be designed for computing the final node embedding for a node A of an example graph 304. It is noted that the computation path 302 represents a portion of the graph neural network that may be designed to graph embed graph 304.

As shown in FIG. 3, the computational path 302 includes an input layer (layer-0) for receiving node feature vectors, a first hidden layer (layer-1), and a second hidden layer (layer-2). The output of the second hidden layer is provided to an output layer (not shown) to compute the final node embedding of node A.

As the last hidden layer in this example, layer-2 is configured to generate a (layer-2) node embedding for node A, which is the target node for computational path 302. To do so, layer-2 aggregates information associated with immediate neighbors of node A, namely nodes B, C, and D. More particularly, layer-2 receives layer-1 node embeddings for nodes B, C, and D and aggregates these layer-1 embeddings to obtain the layer-2 node embedding for node A.

Similarly, the elements of layer-1 are configured to generate the layer-1 node embeddings of nodes B, C, and D based on respective inputs obtained from layer-0. For example, a first element designed to generate a layer-1 node embedding for node B receives as input the features vectors of nodes A and C, i.e., node B's immediate neighbors in graph 304.

As would be understood by a person of skill in the art, layer-2 and the elements of layer-1 are neural network computational units (also referred to as neurons or nodes in the art). As such, they are each associated with a matrix of weights that governs how the unit aggregates its inputs. During training, the weight matrices of layer-1 and layer-2 are learned in order to produce a trained neural network model for graph neural network 302.

Despite improving on graph analytics methods, graph embedding may still require extensive computational resources, particularly for large graphs. To address this problem, distributed graph-embedding has been proposed in the prior art.

According to this distributed graph-embedding approach, as illustrated in FIG. 4, the nodes in a graph 402 are split randomly into multiple sub-graphs, e.g., 404-0, 404-1, and 4042, of smaller sizes. Each sub-graph 404 is then mapped to a respective host 406, which perform graph embedding on the sub-graph assigned to it. The sub-graph embeddings from the various hosts 406 are finally aggregated together to form a graph embedding for the original graph 402.

One drawback of this distributed graph-embedding approach is that, by randomly splitting the original graph 402, connection information between nodes may be lost. For example, when two connected nodes are assigned to different hosts, the relationship between the two nodes is lost in this approach because it is not accounted for by any sub-graph.

A more significant problem, however, is that a sub-graph assigned to a given host may be too sparse to result in a meaningful graph embedding. For example, referring to FIG. 5, if a random split of a graph 502 assigns the nodes labeled 504 to a given host, the resulting sub-graph 506 with only nodes 504 will be a degenerate sub-graph, i.e., without connections between its nodes. Because of this degeneration effect in the sub-graphs, the accuracy of the aggregated graph embedding decreases strongly when the number of involved nodes increases, while the convergence speed disadvantageously decreases.

In order to alleviate the drawbacks caused by this degeneration effect, the distributed graph-embedding approach of the prior art could be improved by sharing information (e.g., node feature information and/or node relationships) between hosts. However, such information sharing would require synchronizing the hosts together, which would increase complexity and resource (e.g., network bandwidth) consumption by the hosts, in addition to potentially being impacted by disconnectivity issues. Above all, the sharing of information between hosts may simply not be allowed for privacy or legal reasons, e.g. due to privacy laws that forbid sharing of private information outside the jurisdiction of a given host, thus between different hosts.

The present invention has been made in light of the above prior art problems.

### SUMMARY OF THE INVENTION

The present invention provides a computer-implemented method for distributed training of a graph-embedding neural network, the method performed at a first server and comprising:

computing, based on a first input data sample, first model data and first embedding data of a first graph neural network, the first graph neural network corresponding to a first set of nodes of a graph that are visible to the first server;

sharing the first model data and the first embedding data with a second server;

receiving second embedding data from a third server, the second embedding data comprising embedding data of a second graph neural network corresponding to a second set of nodes of the graph that are invisible to the first server; and

computing second model data of the first graph neural network based on a second input data sample and the embedding data of the second graph neural network.

According to this method, the first server is provided with embedding data relating to nodes of the graph that are not visible to it (“second embedding data”). These are nodes that the first server may not be aware of or for which it has no feature information. Using the second embedding data, the first server can augment the “input” that it uses to train the first graph neural network (of which it is in charge of training). The augmented “input” accordingly includes the feature data of nodes that are visible to the first server and the second embedding data relating to invisible nodes. Graph embedding accuracy and convergence can thus be improved relative to the prior art distributed graph-embedding technique. Additionally, there is no need for server synchronization, and the sharing of potentially sensitive data among servers (e.g., with a server for which these sensitive data should remain invisible) is avoided.

In an embodiment, the method comprises:

computing third embedding data of the first graph neural network based on the second input data sample and the second embedding data; and

sharing the third embedding data with the second server.

As such, the first server uses the second embedding data in training the first graph neural network to generate third embedding data of the first graph neural network. Like the second model data, the third embedding data is improved by the use of the second embedding data in the training of the first graph neural network. The first server may then share the third embedding data with the second server, allowing the second server or another server to benefit from the third embedding data in training their respective graph neural networks.

In an embodiment, the embedding data of the second graph neural network is computed by a fourth server.

In an embodiment, the third server is a parameter server that receives the embedding data of the second graph neural network from the fourth server.

In another embodiment, the second server is the parameter server.

According to these embodiments, the parameter server intervenes between the first server and another peer server. The peer server may be the fourth server that generates the embedding data of the second graph neural network or another peer server with which the first embedding data is to be shared. These embodiments are advantageous when communication between the first server and the other server is unavailable or unreliable.

In an embodiment, the third server is the fourth server. As such, the first server may receive the second embedding data directly from the server that generated it. This embodiment may be advantageous when direct (e.g., peer-to-peer) communication between the peer servers of the distributed architecture is available. A parameter server that coordinates the sharing of data between peer servers is not necessary according to this embodiment.

In an embodiment, the second server is different than the fourth server. As such, the first server may share its embedding data with a server different than the server that generates the embedding data of a second graph neural network, received by the first server. This embodiment enables increased flexibility in how information is shared between servers.

In an embodiment, sharing the third embedding data with the second server comprises sharing the computed third embedding data and the second embedding data received from the third server. As such, the first server may aggregate with its third embedding data the second embedding data received from the third server. Greater information is thus shared with each embedding sharing step, allowing greater training accuracy and faster convergence at the first server as well as at other servers.

In an embodiment, the third server combines the first embedding data and the embedding data of the second graph neural network to form the second embedding data. The third server may be a parameter server or another peer server. As such, the second embedding data may include an aggregate of embedding data generated by different servers.

In an embodiment, the method comprises sharing the second model data of the first graph neural network with the second server.

In an embodiment, the method comprises receiving third model data from the third server. The third server may be a parameter server or another peer server. The third model data may be an aggregate model that combines models generated by different servers of the distributed system.

In an embodiment, the third model data comprises a model of the graph-embedding neural network.

The third model data may be used by the first server in computing the second model data. In an embodiment, the third model data is aggregated with the first model data to produce aggregate model data, which is used in computing the second model data. The use of the aggregate model data to compute the second model data improves accuracy and speeds up convergence due to the fact that the aggregate model data contains greater graph information (that the first/third model data individually) and may be considered to represent a model that has benefited from further training at this stage.

In an embodiment, computing the second model data of the first graph neural network comprises integrating the embedding data of the second graph neural network into the first graph neural network beginning at a first convolutional layer of the first graph neural network.

In another aspect, the present invention provides a computer server, comprising:

a processor; and

a memory storing instructions that, when executed by the processor, cause the processor to execute a method for distributed training of a graph-embedding neural network according to any of the embodiments described above.

In a further aspect, the present invention provides a system for distributed training of a graph-embedding neural network, comprising: a computer server as described above; and at least one server, connected to the computer server, configured to receive model data and embedding data from the computer server and to return aggregate model data and aggregate embedding data to the computer server.

In an embodiment, any of the above-described acts may be implemented as instructions of a computer program. As such, the present disclosure provides a computer program including instructions that when executed by a processor or a range of processors cause the processor(s) to execute a method according to any of the above-described embodiments.

The computer program can use any programming language and may take the form of a source code, an object code, or a code intermediate between a source code and an object code, such as a partially compiled code, or any other desirable form.

The computer program may be recorded on a computer-readable medium. As such, the present disclosure is also directed to a computer-readable medium having recorded thereon a computer program as described above. The computer-readable medium can be any entity or device capable of storing the computer program.

### BRIEF DESCRIPTION OF THE DRAWINGS

Further features and advantages of the present invention will become apparent from the following description of certain embodiments thereof, given by way of illustration only, not limitation, with reference to the accompanying drawings in which:

FIG. 1 illustrates various applications which may be represented using graphs;

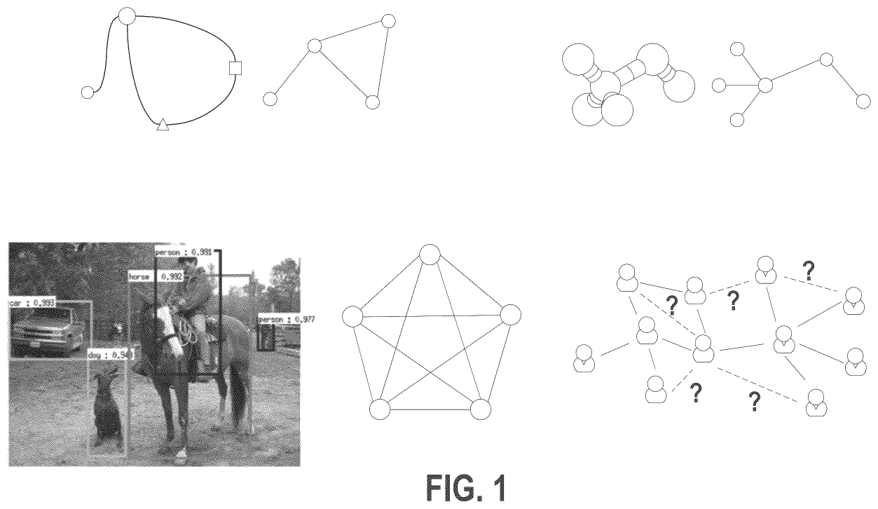

FIG. 2 is an example that illustrates graph embedding;

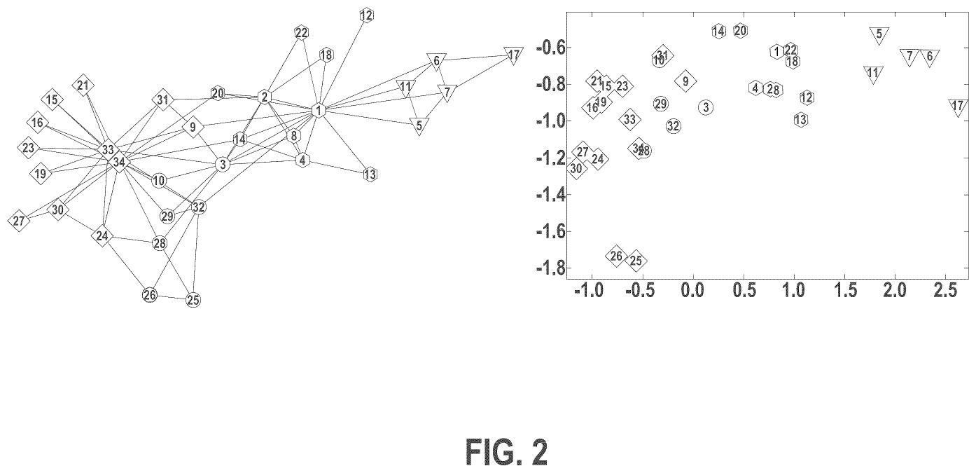

FIG. 3 illustrates a portion of a graph neural network;

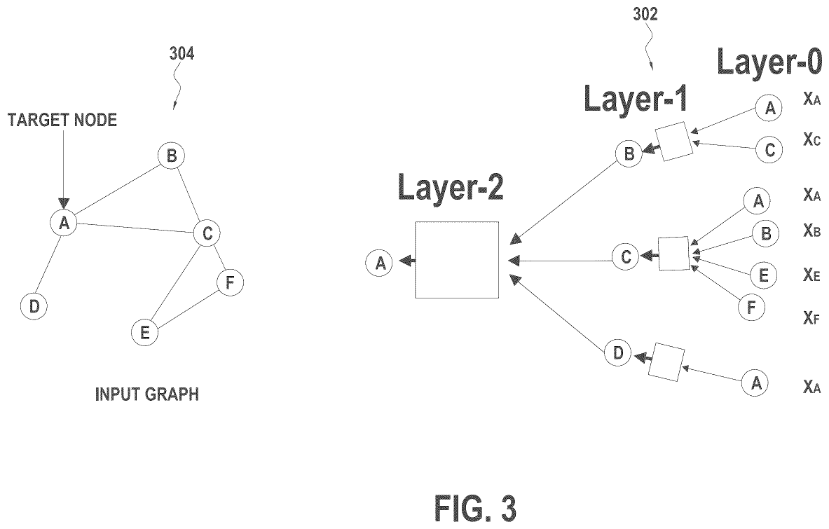

FIG. 4 illustrates conceptually a conventional graph embedding technique;

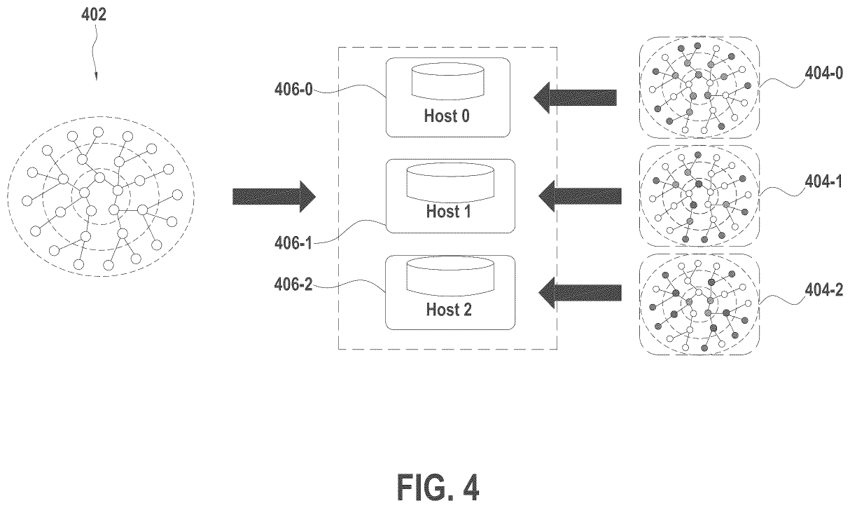

FIG. 5 illustrates a deficiency of the conventional graph embedding technique of FIG. 4;

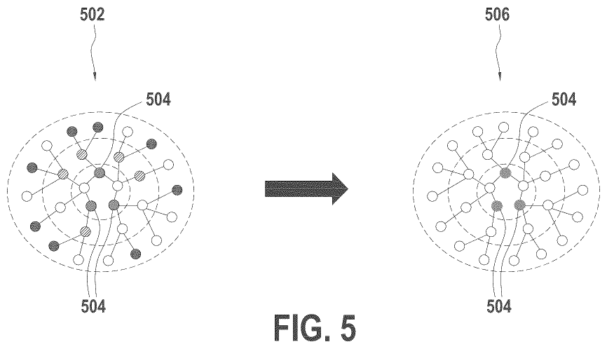

FIG. 6 illustrates conceptually a graph embedding technique according to an embodiment of the present invention;

FIG. 7 illustrates the proposed graph embedding technique with respect to an example sub-graph;

FIG. 8 illustrates a first implementation of the proposed graph embedding technique according to an embodiment of the present invention;

FIG. 9 illustrates a second implementation of the proposed graph embedding technique according to an embodiment of the present invention;

FIG. 10 is a flowchart illustrating a process for distributed training of a graph-embedding neural network according to an embodiment of the present invention;

FIG. 11 is an example illustration of the accuracy performance of the proposed graph embedding technique;

FIG. 12 is an example illustration of the convergence performance of the proposed graph embedding technique; and

FIG. 13 illustrates an example computer device which may be used to implement embodiments of the present invention.

### DETAILED DESCRIPTION OF EXAMPLE EMBODIMENTS

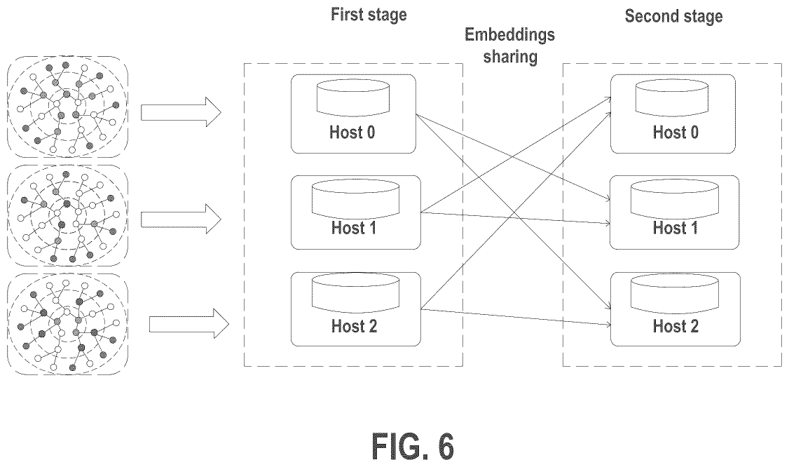

The present invention improves the prior art of distributed graph embedding by using a multi-stage operation. As illustrated in FIG. 6, the multi-stage operation includes at least two stages. After the graph has been split into multiple sub-graphs as described above, in the first stage, each host operates only on the basis of information related to the sub-graph assigned to it. Specifically, each host is aware of the feature information and the node relationships related to only the nodes assigned to it, i.e. the nodes that are “visible” to the host. Other nodes of the graph, of which the host has no awareness, are “invisible” to the host and the host has no information about them.

The first stage may include one or more iterations within each host (through the host's graph embedding network). The number of iterations in the first stage may be the same for all hosts.

At the end of the first stage, node embeddings generated by the various hosts are shared among the hosts. It is noted herein that FIG. 6 is a conceptual figure, and as such that the sharing of embeddings between the hosts may or may not correspond to the illustration of FIG. 6.

Embeddings that are shared may correspond to one or more layers (layer-1, layer-2, etc.) of the graph embedding networks of the various hosts. As such, each host receives embedding information associated with nodes that are invisible to it. Hereinafter, such embeddings will be referred to as shared embeddings or shared embedding data.

In the second stage, each host now operates on the basis of the information associated with its visible nodes as well as on the basis of the received embedding information associated with invisible nodes.

The second stage may include one or more iterations within each host. At the end of the second stage, embedding sharing may take place again. This operation may continue for a set number of iterations or until a convergence condition is met.

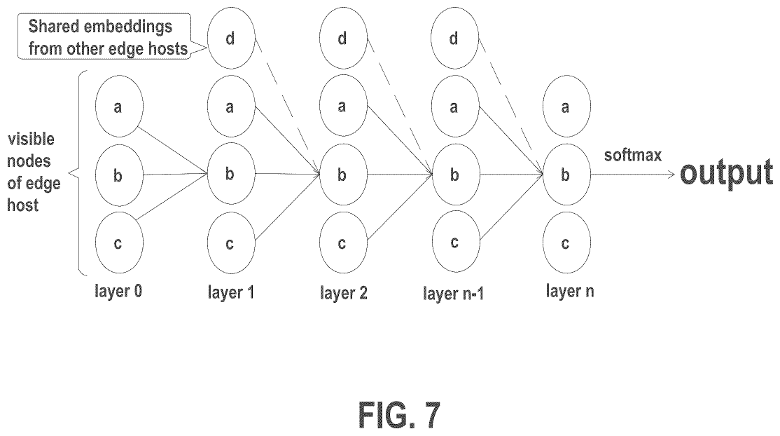

FIG. 7 illustrates the proposed graph embedding technique from the perspective of a given host. It is noted that the graph embedding network shown in FIG. 7 is provided for the purpose of illustration only, and that it may or may not correspond to an actual graph embedding network according to the present invention. For example, connections between the various layers of the network are exemplary and may or may not correspond to an actual implementation.

As shown in FIG. 7, the example graph neural network includes a plurality of layers 0 to n. Layer 0 may be the input layer of the neural network and is configured to receive as input the node features of the graph nodes (a, b, and c) assigned to the host. Each subsequent hidden layer (1 to n) includes a respective neural network computational unit for each of the graph nodes a, b, and c. The output of the graph neural network is provided by a softmax function that operates on the outputs of the final hidden layer n.

During the first stage of operation, the graph neural network operates on the basis of the node feature information (and the node relationships) of only nodes a, b, and c. The node relationships of nodes a, b, and c are illustrated by solid graph edges in the illustration of FIG. 7.

At each iteration through the graph neural network, node embeddings are generated for each of nodes a, b, c. Specifically, the generated node embeddings include node embeddings for each graph node for each hidden layer (layers 1 to n) of the graph neural network.

At the end of the first stage, these node embeddings are shared with other hosts performing the distributing graph embedding task (peer hosts). At the same time, the host receives node embedding information from the other peer hosts, corresponding to invisible nodes of the original graph.

In the second stage of operation, the host incorporates the received node embeddings into its processing. Specifically, as shown in FIG. 7, an additional computational unit (represent by “d” in FIG. 7) may be introduced in each hidden layer. The role of this additional computational unit is to forward the node embeddings of the invisible nodes for a given hidden layer to the next hidden layer. For example, at layer 1, the node “d” computational unit forwards the layer-1 invisible node embeddings to layer 2, and so on.

In an embodiment, a matrix of a fixed size may be used to forward the invisible node embeddings from one layer to the next. As such, the output of a layer (l+1) may be related to the output of the previous layer l, according to the following equation:

H_{local}^{l+1}=σ(A(H_{local}^{l}⊕Sₛₕₐᵣₑ^{l})W_{local}^{l})

where:
H_{local}^{l+1} represents the output (node embeddings) of the (l+1)-th layer,
H_{local}^{l} represents the output (node embeddings) of the l-th layer,
Sₛₕₐᵣₑ^{l} represents the shared node embeddings (i.e., node embeddings of the invisible nodes),
A is a subgraph related matrix,
W_{local}^{l} represents the weight matrix of the local model at the host, and
σ is an activation function.

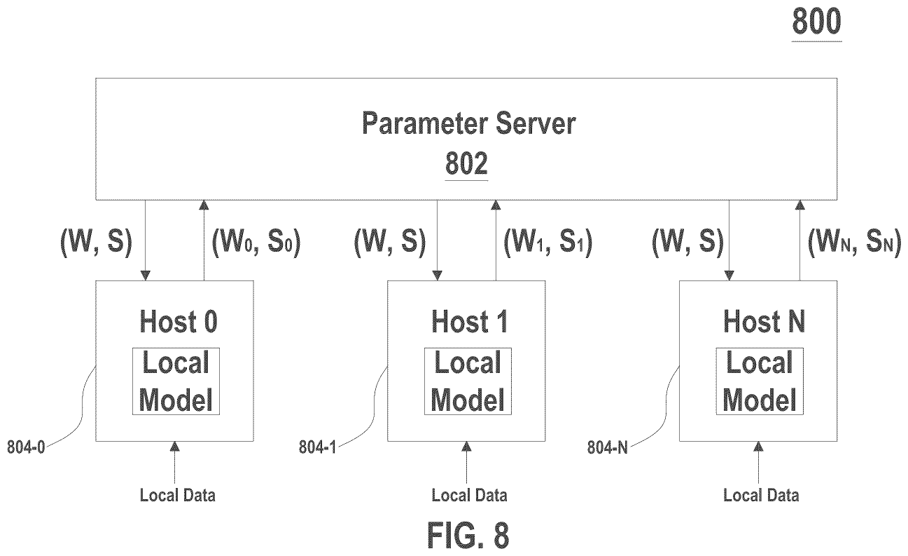

FIG. 8 illustrates a first implementation of the proposed graph embedding technique according to an embodiment of the present invention.

According to this first implementation, the graph embedding technique is performed by a system 800 comprising a parameter server 802 and a plurality of hosts 804-i (i=0, . . . , N) connected to the parameter server 802.

Parameter server 802 may be configured to split the original graph into a plurality of subgraphs as described above, and to assign each of the plurality of sub-graphs to a respective host 804-i of the plurality of hosts 804. In an embodiment, the assignment of sub-graphs to hosts 804 may be based on geographical location of the hosts. For example, the sub-graph assigned to a given host may be associated with feature information that is of a local nature to the host (e.g., located in proximity to the host or in the same legal jurisdiction). In such an embodiment, the hosts may be considered as “edge servers” in the distributed system 800.

In the first stage of operation, each host 804-i generates (i.e., trains) a respective local model Wᵢ based on only local data. The local model Wᵢ generated by the host is a model of the graph neural network corresponding to the subgraph assigned to the host. Specifically, as discussed above, the local model Wᵢ comprises weight matrices associated with the various neural network computational units of the mentioned graph neural network.

The local data used by each host 804-i may correspond to the node feature data associated with the nodes of the sub-graph assigned to the host. In some embodiments, the local data may be data that is accessible by the host 804-i itself only. For example, the local data may data of a private nature that is only available in the jurisdiction in which the host 804-i resides.

In the process of generating the local model Wᵢ, each host 804-i also generates embedding data Sᵢ. The embedding data Sᵢ comprises node embeddings generated by the different hidden layers of the graph neural network operating at the host (e.g. layer-1 node embeddings, layer-2 node embeddings, etc.).

At the end of the first stage, each host 804-i shares its local model Wᵢ and its embedding data Sᵢ with the parameter server 802.

The parameter server 802 aggregates the local models Wᵢ and the embedding data Sᵢ received from the different hosts 804 to generate an aggregate model W and aggregate embedding data S.

In an embodiment, the aggregate model W may be generated by averaging the local models Wᵢ received from the different hosts 804. Similarly, the aggregate embedding data S may be generated as the average of all embedding data Sᵢ received from the different hosts 804. As described above, the aggregate embedding data comprises, with respect to a given host 804-i, embedding data relating to graph nodes that are invisible to the host 804-i.

The parameter server 802 then shares the aggregate embedding data S, as well as possibly the aggregate model W, with some of (or even each of) the hosts 804.

In the second stage of operation, each host 804-i uses the aggregate embedding data S received from parameter server 802 in order to generate a new local model Wᵢ and new embedding data Sᵢ for the host 804-i.

In an embodiment where the parameter 802 does not share the aggregate model W with hosts 804, each host 804-i operates on its local model Wᵢ, using the aggregate embedding data S received from parameter server 802, to generate its new local model Wᵢ and new embedding data Sᵢ.

In another advantageous embodiment where the parameter server 802 also shares the aggregate model W with the hosts 804, each host 804-i operates on the received aggregate model W, using the aggregate embedding data S received from parameter server 802, to generate its new local model Wᵢ and new embedding data Sᵢ. This embodiment is particularly advantageous in that it allows obtaining a global model at the end of training which leverages the data at all of the different hosts. This improves performance of the method in terms of convergence speed and accuracy, when compared with the embodiment where only the local model Wᵢ is used, as discussed further below.

Specifically, using its local data, the host 804-i trains its graph neural network starting from the aggregate model W, instead of the local model Wᵢ generated in the first stage. During this operation, the host introduces the shared embedding data received from the parameter server 802 (as part of the aggregate embedding data S) into the training. This may be done as described above with respect to FIG. 7, by the introduction of the shared embedding data as an additional computational unit at each layer of the graph neural network being trained at the host.

At the end of the second stage, each host 804-i again shares its local model Wᵢ and embedding data Sᵢ with the parameter server 802. The parameter server 802 repeats the aggregation operation described above and shares again aggregate embedding data S (and possibly an aggregate model W) with all the hosts 804. Operation may continue in this manner until the parameter server 802 determines that a convergence condition has been met or for a defined number of iterations.

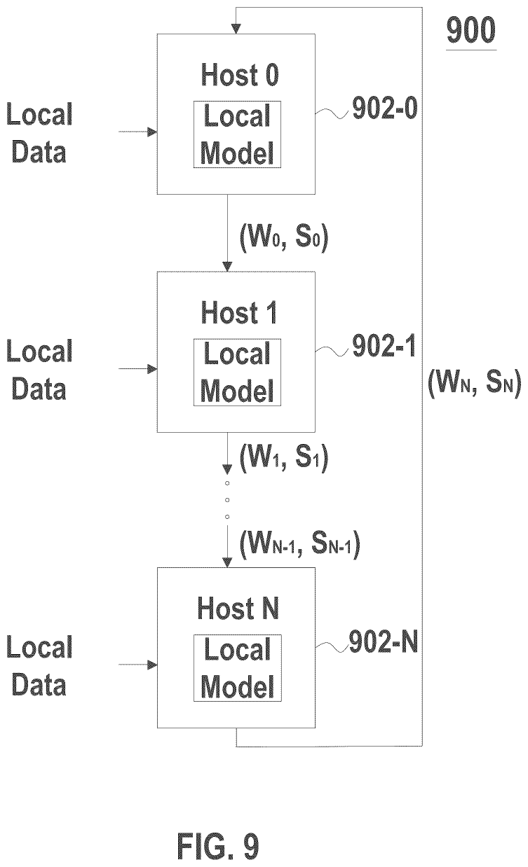

FIG. 9 illustrates a second implementation of the proposed graph embedding technique according to an embodiment of the present invention.

According to this first implementation, the graph embedding technique is performed by a system 900 comprising a plurality of hosts 902-i (i=0, . . . , N) connected in a directed loop configuration.

A server, which may be one of the hosts 902, may be configured to split the original graph into a plurality of subgraphs as described above, and to assign each of the plurality of sub-graphs to a respective host 902-i of the plurality of hosts 902.

In the first stage of operation, each host 902-i generates (i.e., trains) a respective local model Wᵢ based on only local data. The local model Wᵢ generated by the host is a model of the graph neural network corresponding to the subgraph assigned to the host. Specifically, as discussed above, the local model Wᵢ comprises weight matrices associated with the various neural network computational units of the mentioned graph neural network.

The local data used by each host 902-i may correspond to the node feature data associated with the nodes of the sub-graph assigned to the host. In some embodiments, the local data may be data that is accessible by the host 902-i itself only. For example, the local data may data of a private nature that is only available in the jurisdiction in which the host 902-i resides.

In the process of generating the local model Wᵢ, each host 902-i also generates embedding data Sᵢ. The embedding data Sᵢ comprises node embeddings generated by the different hidden layers of the graph neural network operating at the host (e.g. layer-1 node embeddings, layer-2 node embeddings, etc.).

At the end of the first stage, each host 902-i shares its embedding data Sᵢ (and possibly its local model Wᵢ as well) with the host 902-j that follows it in the directed loop. For example, host 902-N shares its model W_{N} and its embedding data S_{N} with the host 902-0, host 902-0 shares its model W₀ and its embedding data S₀ with the host 902-1, and so on.

Simultaneously, each host 902-i receives the embedding data Sₖ (and possibly the local model Wₖ) from the host 902-k that precedes it in the directed loop. For example, host 902-0 receives the model W_{N} and the embedding data S_{N} from the host 902-N, host 902-1 receives the model W₀ and the embedding data S₀ from the host 902-0, and so on.

In the second stage of operation, each host 902-i operates on its model Wᵢ, using the shared embedding data Sₖ received from the preceding host 902-k, in order to generate a new local model Wᵢ and new embedding data Sᵢ.

In an embodiment where host 902-k does not share its local model Wₖ with the next host 902-i in the directed loop, host 902-i operates on its local model Wᵢ, using the shared embedding data Sₖ received from the preceding host 902-k, in order to generate a new local model Wᵢ and new embedding data Sᵢ.

In another embodiment where host 902-k shares its local model Wₖ with the next host 902-i in the directed loop, host 902-i aggregates its local model Wᵢ with the model Wₖ received from the preceding host 902-k to obtain an aggregate model W. In an embodiment, the aggregation may include averaging the local model Wᵢ and the model Wₖ. Once this aggregate model W is computed by host 902-i, host 902-i operates on this aggregate model W, using the shared embedding data Sₖ received from the preceding host 902-k, in order to generate a new local model Wᵢ and new embedding data Sᵢ.

Here as well, this other embodiment is particularly advantageous in that it allows obtaining a global model at the end of training which leverages the data at all the different hosts, thereby improving performance in terms of convergence speed and accuracy, when compared with the embodiment where only the local model Wᵢ is used.

Specifically, using its local data, the host 902-i trains its graph neural network starting from the computed aggregate model W, instead of the local model Wᵢ generated in the first stage. During this operation, the host introduces the shared embedding data Sₖ received from the preceding host 904-k into the training. This may be done as described above with respect to FIG. 7, by the introduction of the shared embedding data as an additional computational unit at each layer of the graph neural network being trained at the host.

In an embodiment, the host 902-i may further combine in the new embedding data Sᵢ the shared embedding data Sₖ received from the preceding host 904-k, i.e., the new embedding data Sᵢ includes the node embeddings generated by the training (which relate to the visible nodes at host 902-i) and the shared embedding data Sₖ received from the preceding host 902-k.

At the end of the second stage, each host 902-i again shares embedding data Sᵢ (and possibly its local model Wᵢ as well) with the host 902-j that follows it in the directed loop, and processing continues as described above.

As in the first implementation, operation may continue in this manner until any of the hosts 902 determines that a convergence condition has been met or for a defined number of iterations. The aggregate model obtained at termination (e.g., in the host that terminates the process) represents a trained model of a graph embedding neural network for the original graph.

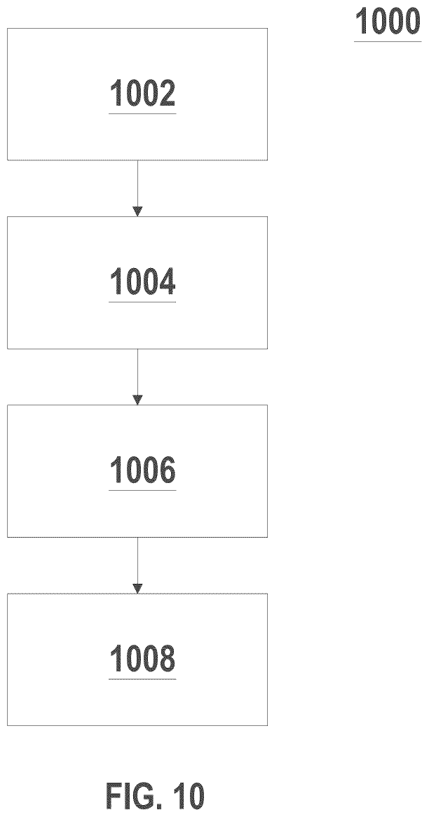

FIG. 10 is a flowchart illustrating an example process 1000 for distributed training of a graph-embedding neural network according to an embodiment of the present invention. Example process 1000 may be performed by a first server of a distributed system. For example, the first server may be a host server, such as a host server 804-i or 902-i as described above, in a distributed system comprising a plurality of host servers performing a distributed training task.

As shown in FIG. 10, process 1000 begins in step 1002, which includes computing, based on a first input data sample, first model data and first embedding data of a first graph neural network.

The first graph neural network may correspond to a first set of nodes of a graph that are visible to the first server. In other words, the first graph neural network is designed to graph embed a sub-graph formed of the first set of nodes.

The first input data sample may be part of local data available to the first server. In an embodiment, the first server may be an edge server (i.e., located in proximity to the local data). The local data may be data of a private nature that is only available in the jurisdiction in which the first server resides.

Subsequently, in step 1004, the process includes sharing the first model data and the first embedding data with a second server. The second server may be another host server (such as a host 902-i as described above) or a parameter server (such as the parameter server 802 as described above). The parameter server may be a centralized server configured to coordinate the distributed training by the host servers.

Next, or concurrently with step 1004, in step 1006, the process includes receiving second embedding data from a third server. The second embedding data may comprise embedding data of a second graph neural network corresponding to a second set of nodes of the graph that are invisible to the first server.

The third server may be another host server (such as a host 902-i as described above) or the parameter server (such as the parameter server 802 as described above).

In an embodiment, the embedding data of the second graph neural network is computed by a fourth server. The fourth server may be an edge server with respect to the second graph neural network. In an embodiment, the second server is different than the fourth server.

In an embodiment, the third server is a parameter server (such as the parameter server 802 as described above) that receives the embedding data of the second graph neural network from the fourth server.

In an embodiment, the third server combines the first embedding data and the embedding data of the second graph neural network to form the second embedding data.

In another embodiment, the third server is the fourth server, i.e., the one that computes the embedding data of the second graph neural network.

Finally, in step 1008, the process includes computing second model data of the first graph neural network based on a second input data sample and the embedding data of the second graph neural network. The second input data sample may be part of local data available to the first server.

In an embodiment, computing the second model data of the first graph neural network comprises integrating the embedding data of the second graph neural network into the first graph neural network beginning at a first convolutional layer of the first graph neural network.

In an embodiment, the process may comprise, after step 1008, sharing the second model data of the first graph neural network with the second server.

In an embodiment, the process may comprise, after step 1008, computing third embedding data of the first graph neural network based on the second input data sample and the second embedding data, and sharing the third embedding data with the second server.

In an embodiment, sharing the third embedding data with the second server comprises sharing the computed third embedding data and the second embedding data received from the third server.

In an embodiment, step 1006 may further comprise receiving third model data from the third server. This third model data may comprise a model of the graph-embedding neural network. For example, this third model data may be an aggregate model obtained by aggregating, at the third server, a plurality of model data received from different servers.

In an embodiment, step 1008 may further comprise aggregating the third model data with the first model data to produce aggregate model data; and computing the second model data starting from the aggregate model data.

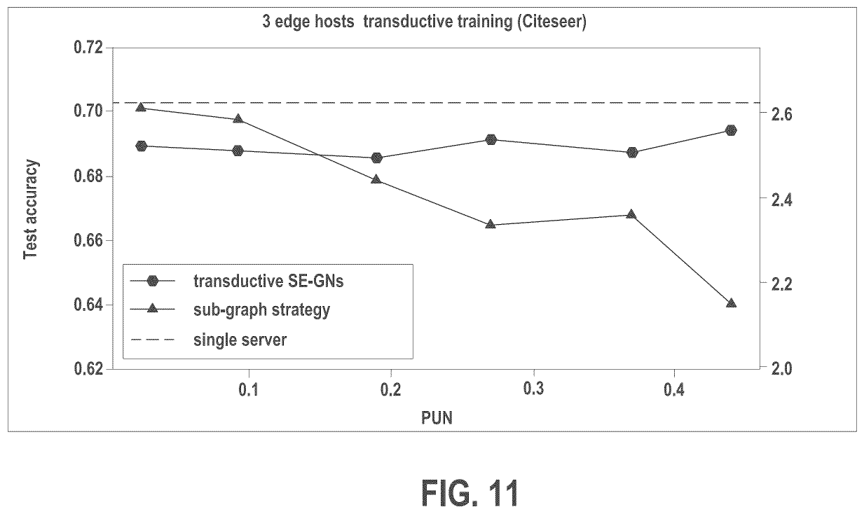

FIG. 11 is an example illustration of the accuracy performance of the proposed graph embedding technique. According to this experiment, a graph consisting of 3327 nodes and 4732 edges was used. Each node in the graph represented a Citseer publication. The edges between the nodes represented forward and backward citations between the publications. The objective of the graph embedding task was to obtain 6 clusters based on the different types of publications present in the dataset.

In the experiment, the graph embedding technique was implemented according to the first implementation described above, where edge hosts operate using an aggregate model W and aggregate embedding data S as discussed previously, received from a parameter server, with a total of three edge hosts

As shown in FIG. 11, the proposed technique (referred to as “transductive SE-GNs”) was compared to the prior art distributed graph embedding technique (“sub-graph strategy”) and to a centralized (“single server”) technique in which the graph embedding is performed on a single server.

Accuracy was measured as a function of the ratio of invisible nodes (at a given host) to total nodes in the graph (PUN). In terms of accuracy, the single server technique represents the theoretical performance limit because the single server has a complete view of all graph information.

As shown, the proposed technique has a more stable accuracy than the prior art technique and significantly outperforms the prior art distributed graph embedding technique as the PUN increases, in terms of accuracy. This confirms that the proposed technique is much more suited for highly distributed graph embedding than the prior art distributed graph embedding technique.

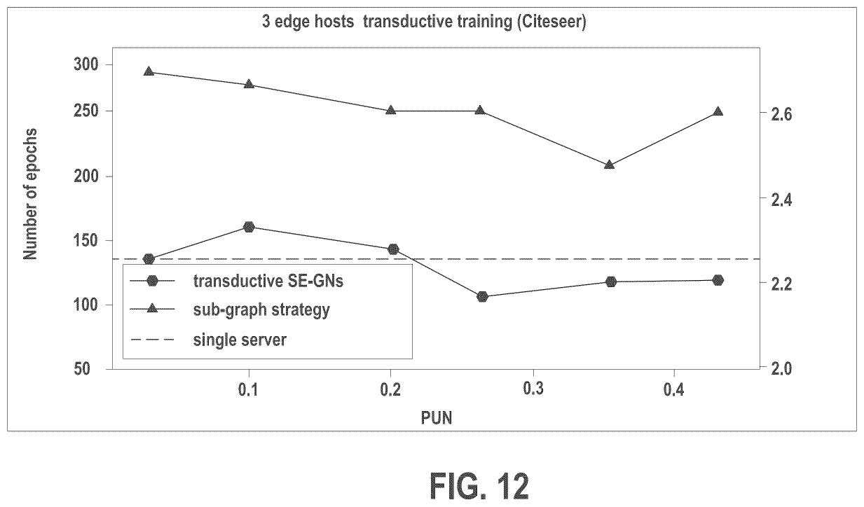

FIG. 12 is an example illustration of the convergence performance of the proposed graph embedding technique. The results of FIG. 12 were obtained using the same experiment as described above with respect to FIG. 11.

As shown, the proposed technique significantly outperforms the prior art distributed graph embedding technique across all PUN values, in terms of convergence speed. The proposed technique even outperforms the single server technique above a certain PUN threshold.

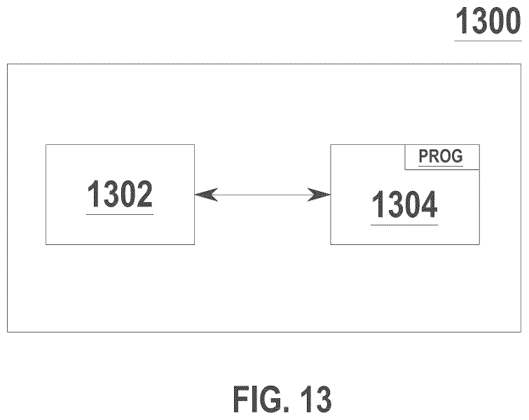

FIG. 13 illustrates a computer server 1300 which may be used to implement embodiments of the present invention. According to embodiments, the above-described parameter server and/or host server may be implemented according to computer server 1300.

As shown in FIG. 13, computer server 1300 includes a processor 1302 and a memory 1304. A computer program (PROG) may be stored on memory 1304. The computer program may include instructions that, when executed by the processor 1302, cause the processor 1302 to execute a method for distributed training of graph-embedding neural networks according to any of the embodiments described herein.

### ADDITIONAL VARIANTS

Although the present invention has been described above with reference to certain specific embodiments, it will be understood that the invention is not limited by the particularities of the specific embodiments. Numerous variations, modifications and developments may be made in the above-described embodiments within the scope of the appended claims.

1. A computer-implemented method for distributed training of a graph-embedding neural network, the method performed at a first server and comprising:
computing, based on a first input data sample, first model data and first embedding data of a first graph neural network, the first graph neural network corresponding to a first set of nodes of a graph that are visible to the first server;
sharing the first model data and the first embedding data with a second server;
receiving second embedding data from a third server, the second embedding data comprising embedding data of a second graph neural network corresponding to a second set of nodes of the graph that are invisible to the first server; and
computing second model data of the first graph neural network based on a second input data sample and the embedding data of the second graph neural network.

2. The method of claim 1, further comprising:
computing third embedding data of the first graph neural network based on the second input data sample and the second embedding data; and
sharing the third embedding data with the second server.

3. The method of claim 1, wherein the embedding data of the second graph neural network is computed by a fourth server.

4. The method of claim 3, wherein the third server is a parameter server that receives the embedding data of the second graph neural network from the fourth server.

5. The method of claim 3, wherein the third server is the fourth server.

6. The method of claim 5, wherein the second server is different than the fourth server.

7. The method of claim 6, wherein sharing the third embedding data with the second server comprises sharing the computed third embedding data and the second embedding data received from the third server.

8. The method of claim 1, wherein the third server combines the first embedding data and the embedding data of the second graph neural network to form the second embedding data.

9. The method of claim 1, further comprising sharing the second model data of the first graph neural network with the second server.

10. The method of claim 1, further comprising receiving third model data comprising a model of the graph-embedding neural network, from the third server, said third model data being used when computing said second model data.

11. The method of claim 10, wherein said third model data comprises aggregate model data obtained by aggregating, at the third server, a plurality of model data received from different servers.

12. The method of claim 10, further comprising aggregating the third model data with the first model data to produce aggregate model data; and using the aggregate model data when computing the second model data.

13. The method of claim 1, wherein computing the second model data of the first graph neural network comprises integrating the embedding data of the second graph neural network into the first graph neural network beginning at a first convolutional layer of the first graph neural network.

14. A computer server, comprising:
a processor; and
a memory storing instructions that, when executed by the processor, cause the processor to execute a method for distributed training of a graph-embedding neural network, the method comprising:
computing, based on a first input data sample, first model data and first embedding data of a first graph neural network, the first graph neural network corresponding to a first set of nodes of a graph that are visible to the computer server;
sharing the first model data and the first embedding data with a second server;
receiving second embedding data from a third server, the second embedding data comprising embedding data of a second graph neural network corresponding to a second set of nodes of the graph that are invisible to the first server; and
computing second model data of the first graph neural network based on a second input data sample and the embedding data of the second graph neural network.

15. A system (800, 900) for distributed training of a graph-embedding neural network, comprising:
the computer server of claim 14; and
at least one server, connected to the computer server, said at least one server configured to receive model data and embedding data from the computer server and to return aggregate model data and aggregate embedding data to the computer server.
